(19) United States
(12) Patent Application Publication
(10) Pub. No.: US 2021/0401034 A1
(43) Pub. Date: Dec. 30, 2021

(54) Bowl Bro

(71) Applicants: Craig Allen McCloud, Princeton, TX (US); Brian Eugene Robinson, Princeton, TX (US)

(72) Inventors: Craig Allen McCloud, Princeton, TX (US); Brian Eugene Robinson, Princeton, TX (US)

(21) Appl. No.: 16/910,409

(22) Filed: Jun. 24, 2020

(51) Int. Cl. A24F 3/00; B67B 7/16; A24F 15/10

(52) U.S. Cl. CPC A24F 3/00; A24F 5/00; A24F 15/10; B67B 7/16

(57) ABSTRACT

The present invention relates to a combination of Lighter holder, tobacco pipe, stash box, bottle opener and snuffer which have been combined for convenience.

### BACKGROUND

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### Field of the Invention

The present invention relates generally to a unique combination of the Lighter -folder, Bottle Opener, Smoking Pipe, Snuffer and Stash Box,

### Description of the Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Various designs for bottle openers adapted to open crown caps are known, having evolved with the crown cap industry. They have combined with other items for convenience. The combination of a crown cap bottle opener with an internal hollow chamber for removably containing a disposable lighter is disclosed in U.S. Pat. No. 4,642,827 issued Feb. 17, 1987 to Karuzas. It employs an oval tubular body with a shaped notch for engaging the crown cap. Karuzas provides a review of related patents including U.S. Pat. No, 4,361,920 issued Dec. 7, 1982 to Zanni and U.S. Pat. No. 4,373,223 issued Feb. 15, 1983 to Miller. In addition, U.S. Pat. No. 4.569,653 issued Feb. 11, 1986 to Becker and U.S. Pat. No. 4,560,344 issued Dec. 24, 1985 to Kietaibl disclose a lighter with hook attached for bottle cap opening. Although the art of combination openers and lighters is crowded, there is not an available device that combines a lighter holder with bottle opener, smoking pipe, snuffer and stash box.

It is also known to conibine a bottle opener with another device that can be used for other purposes, For example, the provision of a bottle opener on a jack knife is well known. The provision of a bottle opener on a gas lighter is taught in U.S. Pat. No. 4,361,920 issued Dec. 7, 1982 to nap In the device of this patent, the gas lighter which is of the piezoelectric type, has an end that is shaped both to be hung up and to be utilized as a bottle opener. The body of the gas lighter acts as a handle fix the opener so that the user will have the necessary leverage when he is removing a crown cap. However, the device of this patent requires a gas lighter of special construction and because of the combined size of the gas lighter-bottle opener, the device is not particularly suited for carrying in one's pocket.

U.S. Pat. No. 4,373,223 issued Feb. 15, 1983, to Mildoy Enterprises discloses a bottle opener that also acts as a container for a disposable lighter. The opener has an elongate plastic body with a hollow internal chamber, open at one end, such that a disposable lighter may be snuggly inserted into the chamber. It has a recessed opening at the opposite end that provides a crown cap removing mechanism. The advantage of this known opener is that it can be conveniently carried in a purse or pocket without significantly adding to the user's collection of paraphernalia. There are disadvantages however to this known container opener, including the fact that the container opener must be longer than the body portion of the lighter (which contains the lighter fluid) in order to provide room for the opening mechanism. This makes the device more awkward to carry in one's pocket. In addition, the container opener will not stand up on its end because of the rounded opening mechanism at the bottom end. Furthermore, it may be difficult to remove the disposable lighter from the opener without the use of some sort of tool.

None of the prior art methods have been found to be completely suitable to meet these needs and are cumbersome. The present invention provides such a method and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

In order to solve the above problems, the method and system of this invention focused and has been designed and constructed in a manner that makes it great.

Another embodiment of the present invention is Lighter holder with a hollow chamber in which the lighter can be longitudinally inserted into the chamber. The invention has a set screw that can be operated for height adjustment and to compensate for loose fitting lighters. When the lighter is removed, the cavity can be used as a tobacco pipe. When the lighter is adjusted to a tall position, the cavity created by the bottom of the lighter and the bottom/sides of cavity, can serve as a stash box.

Another embodiment of the present invention is that when its turned horizontally to 90 degees, the long end of the device serves as a bottle opener. The short edge contacts the bottle cap from below and the radiused edge contacts the center of the bottle cap. When an uplift motion is applied, the bottle top becomes dislodged.

It is therefore an object of the invention to provide a new and improved method which can be used for multiple purposes such as Lighter Holder, Bottle Opener, Smoking Pipe, Snuffer, and Stash Box.

it is still a further object of the present invention to provide a new and improved tool set which may be easily and efficiently manufactured and marketed.

it is another object of the present invention to provide a new and impro tool set which is of a durable and reliable construction.

The present invention is of sufficient strength for its opening function, the body is made substantially of metal plate and/or wood having sufficient thickness that it will not bend or tail when it is used properly as a bottle opener.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows tool set of the desired invention.

FIG. 2 shows inner view of the pipe that can be extended.

FIG. 3 shows the invention when used as the bottle opener.

FIG. 4 shows the stash box.

FIG. 5 shows the snuffer function.

FIG. 6 shows exploded view of the invention.

FIG. 7 shows lighter holder as per the claimed embodiment of the invention.

FIG. 8 shows sliding tube function.

FIG. 9 shows assembly direction.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

Unless otherwise defined, all terms (including technical and scientific terms) used herein have the same meaning as commonly understood by one having an ordinary skill in the art to which the invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques are disclosed. Each of these has individual benefit and each can also be used in conjunction with one or more, or in some cases all, of the other disclosed techniques. Accordingly, for the sake of clarity, this description will refrain from repeating possible combination in an unnecessary fashion. Nevertheless, the specifications and claim/s should be read with the understanding that such combinations are entirely within the scope of the invention and the claim/s.

A combination bottle opener, lighter holder constructed in accordance with the invention has an elongate body with an internal hollow chamber. Lighter holder is a cavity the lighter fits into. The set screw allows for height adjustment and to compensate for loose fitting lighters. When the lighter is removed, the cavity can be used as a tobacco pipe.

When the lighter is adjusted to a tall position, the cavity created by the bottom of the lighter and the bottom/sides of cavity, can serve as a stash box. When turned horizontal 90 degrees, the long end of the device serves as a bottle opener. The short edge contacts the bottle cap from below and the radiused edge contacts the center of the bottle cap. When an uplift motion is applied, the bottle top becomes dislodged.

The telescopic mouthpiece tube slides inside a through hole in the base and the sliding tube is held into place by the steel ball. The steel ball remains under a constant load due to the compression of the O-ring.

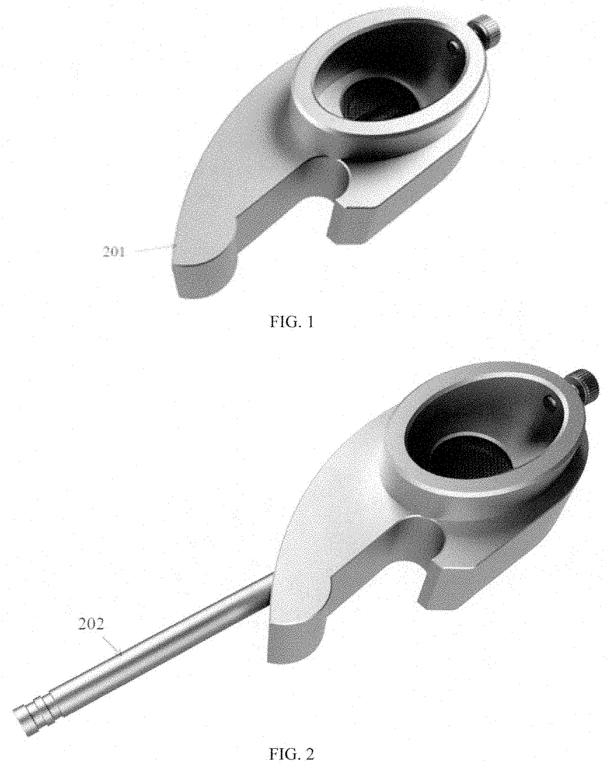

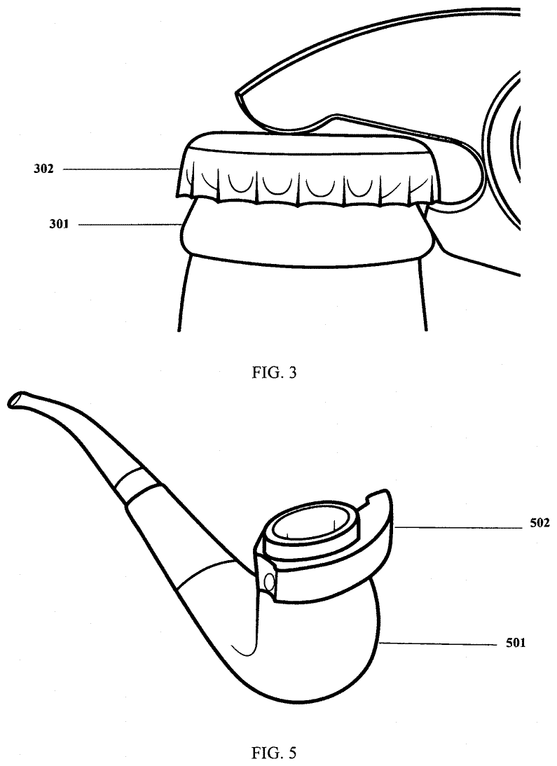

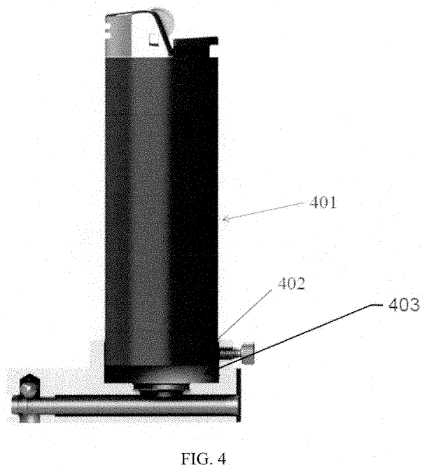

FIG. 1 shows complete view of the invention. FIG. 2 shows the invention when is used as a tobacco pipe and the pole length can be extended 202 or retracted 201. FIG. 3 shows the invention when used as the bottle opener, the crown cap 302 is lifted from the bottle 301 with the help of applicants invention. FIG. 4 shows stash box 401 shows lighter, 402 bottom portion of the lighter, 403 shows stash box. FIG. 5 shows snuffer function 501 is the smoking pipe, 502 shows snuffer as a use of the invention.

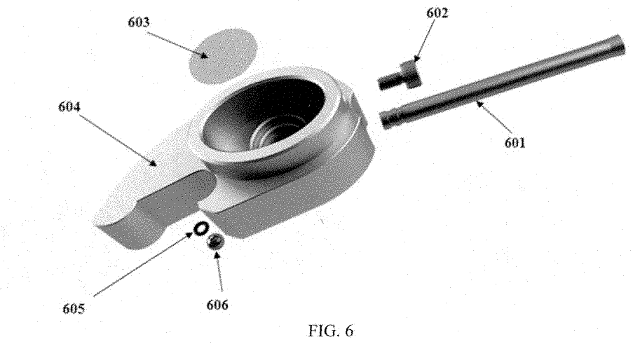

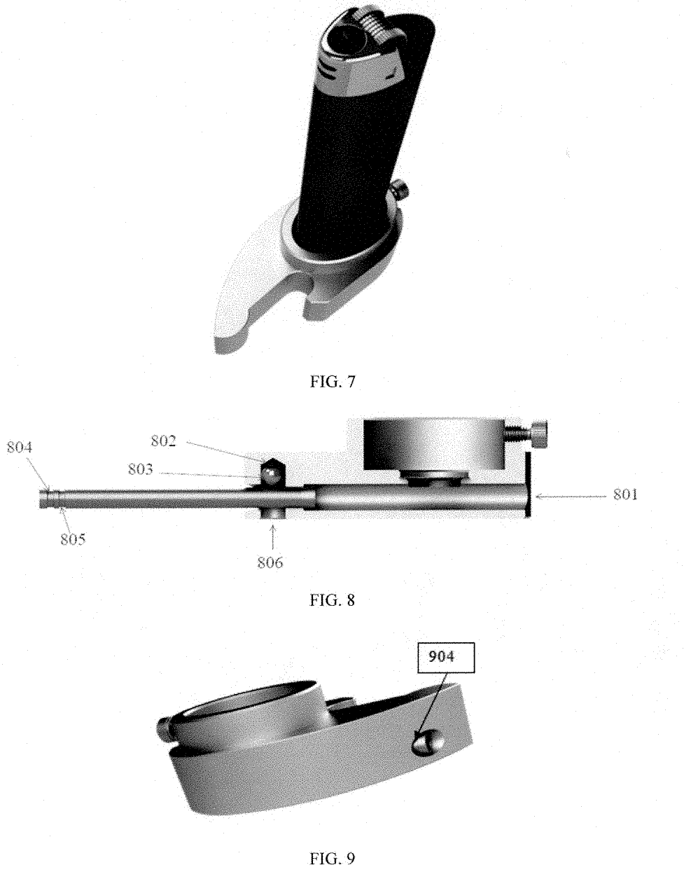

FIG. 6 shows exploded view of the invention. There is a stainless steel tube 601. One thumb screw 602, a screen made up of brass or stainless steel 603, there is a base of Anodized Aluminum 604, there is O-ring—Rubber 605 and Ball made of Stainless Steel 606. FIG. 7 shows lighter holder as per the claimed embodiment of the invention.

Another embodiment of the invention relates to its sliding tube as shown in FIG. 8 which is held into place by the steel ball. The steel ball remains under a constant load due to the compression of the O-ring. The O-ring is placed inside a hole created by a standard drill bit. The steel ball is then placed after the O-ring As the tube is forced thru the thru hole the pressure created on the stainless-steel ball forces the O-ring to compress. To revert back the stainless-steel ball will “lock” into the 2nd slot located on the stainless-steel tube. This keeps the tube in a locked retracted position. The tube can be extended to maximum position to create distance from the face and pipe bowl by creating and extending mouthpiece. The tube cannot be pulled all the way out from this position because the tube end has a larger diameter than the tube body. When fully retracted slot one 804 remains outside the body of the aluminum base to provide a surface that can used to pull the tube from the aluminum base.

FIG. 8 shows assembly direction 801 for tube, O ring 802, stainless steel ball 803, Slot one 804 and two 805 and assembly direction 806 for O ring and stainless steel ball. FIG. 9 shows assembly direction with Slot one 904.

The above disclosed invention has a number of particular features which should preferably be employed in combination although each is useful separately without departure from the scope of the invention. While I have shown and described the preferred embodiments of my invention, it will be understood that the invention may be embodied otherwise than as herein specifically illustrated or described, and that certain changes in the form and arrangement of parts and the specific manner of practicing the invention may be made within the underlying idea or principles of the invention within the scope of the appended claims.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1) A combination of tool set comprising:
a. Lighter Holder;
b. Adjustable Lighter Height using a larger cap set screw a used as a thumb screw;
c. Side to side and front to back compensation for loose fitting lighters;
d. Bottle Opener;
e. Smoking Pipe with an extendable mouthpiece in which tube slides inside a hole from the base;
f Snuffer;
g Stash Box.

2) Lighter holder with a hollow chamber in which the lighter can be longitudinally inserted into the chamber.

3) the cavity can be used as a tobacco pipe and can serve as a stash box.

4) the combination of tool set of claim 1 comprises:
a. Tube;
b. Thumb Screw;
c. Screen;
d. Base;
e. O-ring
f. Ball.
